(19) United States
(12) Patent Application Publication
(10) Pub. No.: US 2012/0203865 A1
(43) Pub. Date: Aug. 9, 2012

(54) APPARATUS AND METHODS FOR PROVIDING BEHAVIORAL RETARGETING OF CONTENT FROM PARTNER WEBSITES

(75) Inventor: William W. Graham, JR., Mill Valley, CA (US)

(73) Assignee: CBS INTERACTIVE, INC., San Francisco, CA (US)

(21) Appl. No.: 13/021,281

(22) Filed: Feb. 4, 2011

(51) Int. Cl. G06F 15/16

(52) U.S. Cl. 709/219

(57) ABSTRACT

Various embodiments for providing content targeted to a user on a first website based on what sites the user visited previously are described. In an embodiment, a website may be in partnership with the first website. The first website may serve an object to its partners and may create a user ID and a cookie when the object is requested. The cookie may be placed on a client by the first website. When the client loads a page at the first website, the first website may use the user ID from the cookie to look up information stored about the client. The first website may use the information to determine what is of interest to the user of the client, and to select content for display according to that interest. Other embodiments are described and claimed.

### BACKGROUND

Companies that advertise or provide content on a third-party website often have their own online presence to provide information about their products and services. When a consumer visits a company's site, the consumer may navigate away from the website, for example, to conduct research on a product of interest at a third-party site. The company may want to be able to target advertising or other content related to the area of interest to the consumer when the consumer navigates away. Accordingly, there may be a need for an improved apparatus and methods for providing targeted content from user behavior.

### BRIEF DESCRIPTION OF THE DRAWINGS

FIG. 1 illustrates a system for behavioral retargeting in accordance with one or more embodiments.

FIG. 2 illustrates a second system for behavioral retargeting in accordance with one or more embodiments.

FIG. 3 illustrates a site application in accordance with one or more embodiments.

FIG. 4 illustrates a merchant website in accordance with one or more embodiments.

FIG. 5 illustrates a sequence diagram in accordance with one or more embodiments.

FIG. 6 illustrates a logic flow in accordance with one or more embodiments.

FIG. 7 illustrates a second logic flow in accordance with one or more embodiments.

FIG. 8 illustrates a computing architecture in accordance with one or more embodiments.

### DETAILED DESCRIPTION

Various embodiments are directed to providing behavioral retargeting of content, such as advertising, from partner websites. Behavioral retargeting may refer to the practice of dynamically selecting content to display to a client device based on previous actions taken on the client device. Actions that may be useful in selecting content to use in retargeting may include, for example, viewing a web page, following hyperlinks, or searching.

Embodiments may include a cooperation between two or more websites, for example, a website for a company that sells products or services, and an independent website that offers consumer information, or different products or services. In an embodiment, one website (website A) may provide an object to be embedded in the other website (website B). When a page at website B is loaded, the request to load the object from website A may cause website A to generate an identifier for the client device and insert the identifier into a cookie that is provided to website B along with the embedded object. The load request may further include metadata about what was viewed at website B. When the client device later views website A, website A may examine the cookie and use the identifier to locate the metadata about what was viewed at website B. The metadata may allow website A to assign a segment to the client device based on the metadata. The segment may be provided to a content service, e.g. an advertising service. The content service may select content for the client device based on the segment that is related to website B, for display in the content served by website A at the client device.

Conventionally, websites served from different domains or from separate entities do not have access to the data that another website may store on a client device, for example, a cookie file. For example, in the above discussion, website B may be a cellular telephone service provider. A user considering signing up for a cellular phone service may visit website B. The user may wish to obtain independent information about the cellular phone service and may, after examining service plans and device options, navigate to website A, which may be a user forum or consumer review website. Conventionally, a cookie created by website B about what website pages the user has viewed at website B would not be accessible to website A. Website A would therefore not be able to provide any input to a content selection process for content selection at website A. Embodiments of the invention seek to overcome these and other issues surrounding behavioral retargeting of advertising or other content.

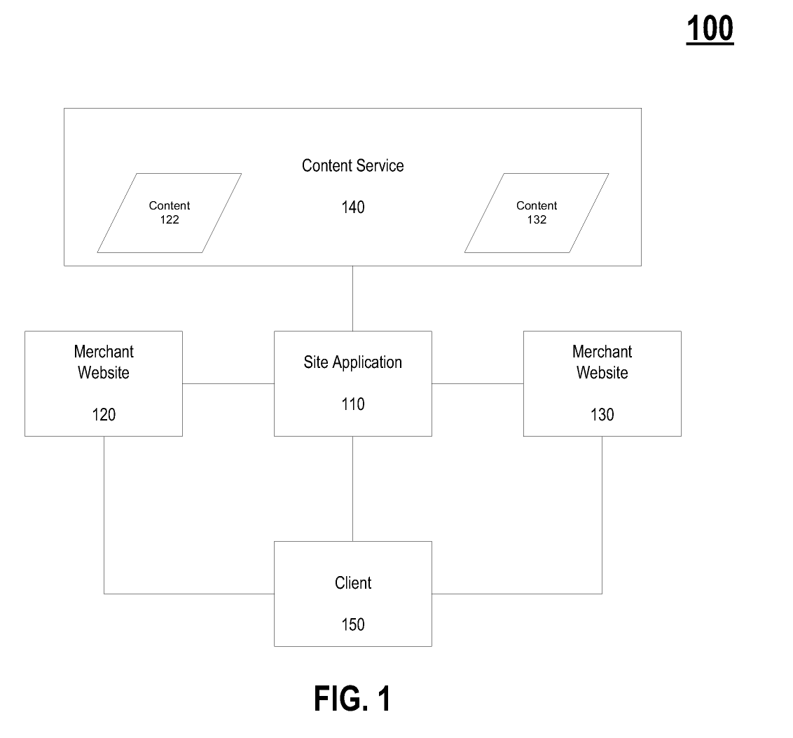

FIG. 1 illustrates a system 100 to provide targeted content, such as advertising, at a website, where the content is targeted based on the interactions of a client device with a different independent website. In one embodiment, for example, the system 100 may comprise a computer-implemented system having multiple electronic devices, such as a site application 110, merchant websites 120, 130, a content service 140, and a client 150.

As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented by one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The computing entities or devices of system 100 may be communicatively coupled via a network, which may be implemented via various types of communications media, including wired or wireless communications media. The network may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The computing entities or devices of system 100 may include various types of standard communication elements designed to be interoperable with the network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between computing entities or devices of system 100 can be in the form of a data packet adapted to be transmitted between two or more computer processes. The data packet may include a cookie and/or associated contextual information, for example.

In an embodiment, system 100 may include site application 110. Site application 110 may comprise a network server implementing a website hosting application, a web browser, or other suitable application for serving content to clients, such as client 150. A website may include one or more web pages of text, images, video, audio, hyperlinks, and/or other content types formatted to be viewed in an application such as a web browser, for example, Internet Explorer by Microsoft Corp., Safari by Apple Inc., or Chrome by Google. The pages may include, for example, hypertext markup language (HTML) coded pages, extensible markup language (XML) coded pages, JAVA applets, plain text, and so forth, or a combination thereof.

Site application 110 may serve a number of different web pages containing varied content. The content may include default content that is served to all users, or that is served in the absence of any additional information received or detected about a client's previous on-line activity. The content may also include a section that can be dynamically updated or loaded separately from the rest of the page, where the content for the section may come from content service 140 as will be described later. In some cases, the site application 110 may be operated by an entity, such as a corporation, association, or individual, and hosted primarily from one network address.

Site application 110 may serve many types of web sites, such as, without limitation, a news site, an online storefront, a consumer product information site, a blog, a social networking site, a gaming site, a user forum site, an entertainment site, a sports site, a professional sports site, a college sports site, a high school sports site, a financial services site, a financial products site, and other websites aggregating a certain type or genre of information.

Site application 110 may serve one or more kinds of content. For example, site application 110 may serve consumer information, news, multimedia content, lifestyle content, entertainment content, and/or product content. In an embodiment, site application 110 may serve at least some content that is related in some way to content at merchant website 120, 130. For example, site application 110 may serve independent information, such as reviews or performance metrics, about products or services for sale at merchant website 120, 130. Site application 110 may offer services for sale that relate to products for sale on merchant website 120, 130. Site application 110 may offer components for sale that may add functionality to products for sale at merchant website 120, 130. Site application 110 may provide content on social networking opportunities, such as user forums, fan groups, community activities, or other events related to the product, service or content on merchant website 120, 130. The embodiments are not limited to these examples.

In an embodiment, an entity that operates site application 110 may be in cooperation with the entities that operate merchant website 120, 130 and merchant website 130. The cooperation may allow merchant website 120, 130 to share information, determined from the interactions of client 150 at merchant website 120,130, with site application 110. The partnership may further allow site application 110 to provide a means for tracking the movement of client 150 from merchant website 120, 130 to viewing the content served by site application 110. The cooperation may generally provide for displaying content, such as advertising, at site application 110 on behalf of merchant website 120.

Site application 110 may serve an object to merchant website 120, 130. Merchant website 120, 130 may include a call to that object in one or more of its web pages. When such as page from merchant website 120, 130 is loaded on client 150, the call to the object may include information about the pages that client 150 viewed and the actions client 150 took at merchant website 120, 130.

Site application 110 may create a unique user identifier (ID). In some cases, the unique user ID may be made anonymous so that is may not be linked to a specific identity of a particular user for privacy concerns. The anonymous unique user ID may be assigned, for example, by site application 110 when merchant website 120, 130 first accesses site application 110 for a given client. An anonymous unique user ID may be assigned by generating a new unique user ID and assigning it to the current session with a particular client. A unique user ID may be assigned based on some aspect of the client, such as a network address, or based on some aspect of the user obtained from the client, such as a login ID, e-mail address previously provided, etc.

Site application 110 may store the information received from merchant website 120, 130 indexed by the user identifier, generate a cookie file for the user and set the cookie on client 150.

In an embodiment, merchant website 120, 130 may provide content in one or more pages to a client, such as client 150. In an embodiment, merchant website 120, 130 may be a website served from a different domain than the domain of site application 110. In an embodiment, merchant website 120, 130 may be served by an entity that is separate from the entity that serves site application 110. Merchant website 120, 130 may include, for example, a website for an original equipment manufacturer (OEM), a software company, a service company, an online storefront, a news provider, a media provider, a performance group, or any other business or content provider. The embodiments are not limited to these examples.

The web pages of merchant website 120, 130 may have data associated with them, such as a page type, a page category, a site identifier, an asset, metadata, or other information. Examples of a page type may include a search page, a content page, a review page, a download page, and so forth. A page category may refer to the content of the page, e.g. what the page is about, such as a specific product or a topic. A site identifier may identify the parent site for the page. An asset may refer to a product or service.

In an embodiment, merchant website 120, 130 may collect data associated with interactions of client 150 with merchant website 120, 130. Examples of data that may be collected include: pages viewed, products or services associated with viewed pages, searches performed, categories of products or services viewed, types of pages viewed, and so forth. Pages at merchant website 120, 130 may be tagged with metadata tags, and merchant website 120, 130 may collect the tags from each page viewed by a particular requesting client, and store the tags. The collected data may be stored until the client navigates away from merchant website 120, or may be stored for a longer period.

Merchant website 120, 130 may analyze and/or aggregate the collected data and generate metadata about the collected data. In addition to collecting or keeping track of the tags of the pages viewed, merchant web site 120, 130 may perform further analysis on the collected data. For example, merchant website 120, 130 may count the number of times a tag was collected, e.g. the number of pages having that tag that were viewed. Merchant website 120, 130 may perform statistical analysis on the tags to determine a most likely area of interest. For example, if most of the pages viewed have a “laptop” tag, while relatively few of the pages viewed have a “games” tag, merchant website 120, 130 may generate or assign a “laptop” metadata tag to the browsing session from that client, rather than a “games” tag. In an embodiment, merchant website 120, 130 and site application 110 may cooperate on what metadata site application 110 will recognize.

One or more pages at merchant website 120, 130 may include a link or a reference to an object that is served remotely by site application 110. In an embodiment, either or both of the link or reference and the object may be non-visible on the page. For example, the object may be a non-displayed piece of code, such as a Javascript. The code may be used to collect metadata about the page and send it to site application 110. The object may be an image or text that is clear, e.g. non-colored or transparent, or may be a very small image, for example, a one pixel image. In an embodiment, the object may be visible, for example as a graphic, and image, text, and so forth. When the merchant website page is loaded by client 150, the non-displayed link or reference may cause client 150 to contact site application 110 to retrieve the object.

The request to load the object may include some or all of the metadata collected or assigned to that client 150 up to the request time. In an embodiment, the request to load the object may be in the form of a uniform resource locator (URL) having metadata in the form of query string parameters. In addition to providing the object, site application 110 may also provide a cookie or other identification means to place on client 150, as will be described in greater detail below.

Client 150 may be a wired or wireless computing device operating a browser, application viewer or other application program suitable for receiving and displaying content served by site application 110 and by merchant website 120, 130. Client 150 may receive and respond to control directives from a user, for example, input from an input device that causes the browser to connect to a specific website, download a file, fill out a form, follow a hyperlink, and so forth. Client 150 may receive and store information about the user's activity online. For example, client 150 may store a browser history for a browser application operating on client 150. The browser history may maintain a list of all of the website addresses or uniform resource locators (URLs) visited by the user within a certain time period. Client 150 may receive and store cookie files from websites visited, such as from merchant websites 120, 130. The cookie files may record actions taken at a particular website, including links followed, search strings entered, a product purchased, and/or metadata associated with the web pages visited at the website. Client 150 may also keep a record of input commands received from a user, output presented on a display for the user, biometric information about the user, sensor information for various sensors implemented by the client 150 (e.g., proximity sensors, motion sensors, environmental sensors, and so forth), applications executing on the client 150, state information for the client 150, and any other information that may assist in predicting or identifying the user's activity online. Additionally or alternatively, another network device may record information about the user's behavior online, such as merchant websites 120, 130, the site application 110, or the content service 140, for example. The embodiments are not limited to these examples.

In an embodiment, system 100 may include content service 140. Content service 140 may be in communication with site application 110. Site application 110 may analyze the data received from merchant website 120, 130, as well as other information about a client's activity on-line, to select a segment or otherwise provide user activity information to content service 140. Content service 140 may receive the information from site application 110 to select content, such as content 122 and content 132, according to the received information. Content service 140 may provide the selected content to site application 110. The selected content may then be inserted into the content served by site application 110 and displayed to client 150, or presented separately from the content served by the site application 110, such as in a separate graphical user interface (GUI) view or web page. The embodiments are not limited in this context.

In an embodiment, content service 140 may be a website itself, which selects content to display at site application 110. In another embodiment, content service 140 may store and provide content to site application 110 without being accessible independently via network 150.

Content service 140 may store and provide content from a plurality of independent sources, such as merchant website 120, 130 and select, as a service, which content to provide to site application 110 based on information about a user received form site application 110. For example, content 122 may be owned by merchant website 120 and content 132 may be owned by merchant website 130. When a user that previously visited merchant website 120 arrives at site application 110, site application 110 may request content from, or provide user information to, content service 140 and may receive content 122 for display.

Content service 140 may be operated by the same entity as for site application 110, or may be independent. In general, the entity or entities that provide content via content service 140 desire to display their content to a more specific audience. In an embodiment, content service 140 may specify the categories of users or consumers that it can target. The target audiences may be grouped into segments. A segment may represent, for example, a demographic, e.g. 18-25 year-old men; an advertising category, e.g. football fan; an interest category, e.g. bird-watching; a product category, e.g. digital camera; and so forth. A segment may further include an identifier for a specific entity, such as merchant website 120, 130. In another embodiment, site application 110 may specify the targets that content service 140 may then select from. The embodiments are not limited in this context.

In general, content service 140 may store content to supplement content provided by the site application 110. The content of site application 110 and of content service 140 may comprise any multimedia information, including text, audio, video, images, pictures, graphics, icons, and so forth. In some cases, the content supplied by merchant website 120, 130 may be related to the content provided by the site application 110. In an embodiment, for example, content service 140 may be an advertising service, and the content that is selected may include advertising. In another embodiment, merchant website 120, 130 may be a media provider, and the content selected may include movie trailers, video files, television programs, full-length movies, music files, etc. In another embodiment, merchant website 120, 130 may be a news provider or a journal, and the content selected may include articles or news items. In another embodiment, merchant website 120, 130 may be a merchant of products or services, and the content selected may be advertisements or links to more information about a particular product or service. The embodiments are not limited to these examples.

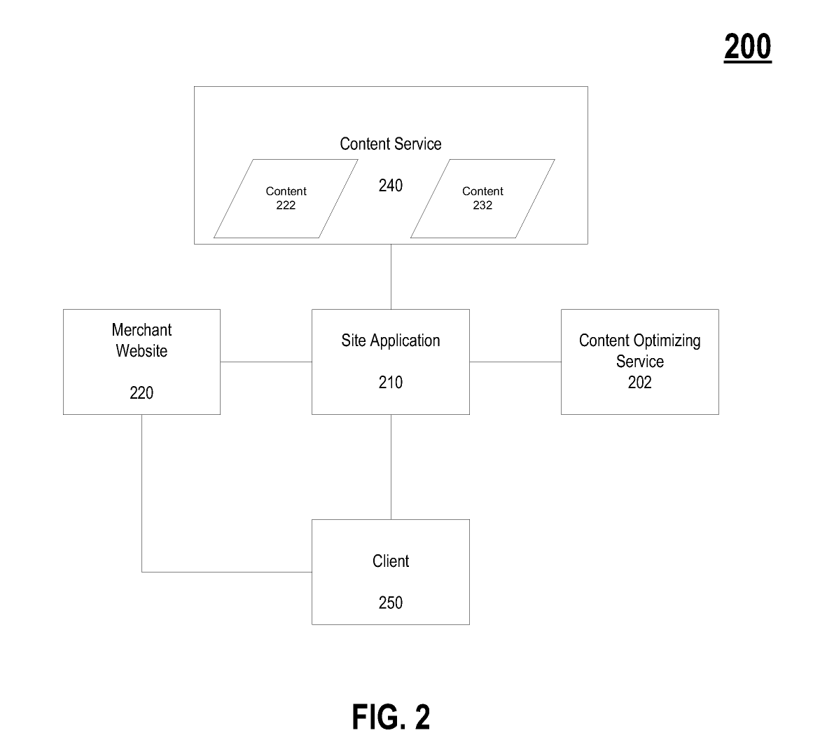

FIG. 2 illustrates a system 200 similar to system 100. System 200 differs from system 100 by the addition of content optimizing service 202. Only one merchant website is shown, however, system 200 may include one or more merchant websites in addition to merchant website 220. Content optimizing service 202 may collect information about user activity online. User activity may refer to control directives received at client 250 that cause client 250 to request and receive content from merchant website 220 and/or site application 210. The control directives may include, for example, selecting a hyperlink with an input device, typing a search string into a search interface, typing a URL into a browser. Content optimizing service 202 may compare the collected activities against a set of rules in order to classify the user into one or more segments. Content service 240 may receive the segment information from content optimizing service 202 via site application 210, and may use the segment to select content to insert into the content served by site application 210 and displayed to client 250, or present separately from the content served by the site application 210, such as in a separate graphical user interface (GUI) view or web page.

In an embodiment, content optimizing service 202 may be invoked when a client, such as client 250, initiates a connection to site application 210, for example, by requesting and loading a web page from site application 210. In an embodiment, content optimizing service 202 may be invoked from client 250 when the client begins loading the web page from site application 210. The web page may contain a script, such as a Javascript, that runs when the client loads the web page. The script may invoke content optimizing service 202. In an embodiment, content optimizing service 202 may be invoked by the requested web page from site application 210.

When content optimizing service 202 is invoked, the content optimizing service 202 may access the information about the user. The information may be accessed by content optimizing service 202 directly from cookie files placed on client 250 by websites in the same domain as content optimizing service 202. The information may be received from site application 210 from, for example, the cookie file placed on client 250 by site application 210, cookie files placed on client 250 by other websites in the same domain as site application 210, a browser history, and/or older activity data stored about that user at site application 210 or content optimizing service 202. Content optimizing service 202 may also receive, from the invoking web page or client, information such as a category, a page type, a site identifier, and/or an identifier for an asset associated with the invoking web page. Still other information that may be provided to content optimizing service 202 may include, for example, the uniform resource locator (URL) of the referring web page, an edition or version of the invoking web page, and an asset type of the asset associated with the current web page. Content optimizing service 202 may store some or all of the received information as data for the user, indexed by the user ID.

Content optimizing service 202 may analyze some or all of the data about a given user to determine a segment for content selection. Analyzing may include comparing activities or events in the data to rules or steps to arrive at a segment when a rule is matched or a series of steps is complete.

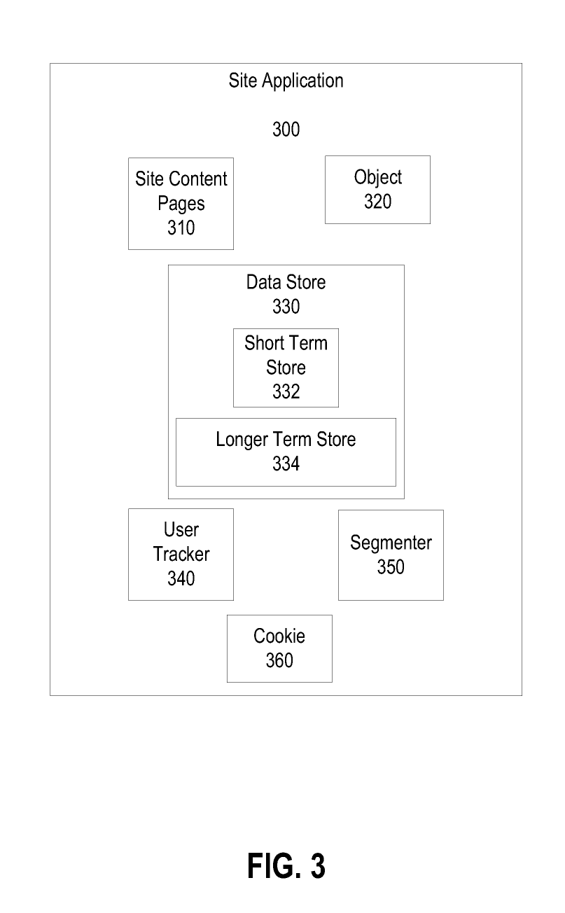

FIG. 3 illustrates a block diagram of a site application 300. Site application 300 may be a representative embodiment of site application 110 or site application 210. Site application 300 may include one or more functional components, such as, but not limited to, user tracker 340 and segmenter 350. Site application 300 may comprise site content pages 310, an object 320, and a data store 330.

Site content pages 310 may include one or more web pages served by site application 300. Site content pages 310 may include, for example, files coded in HTML, XML, JAVA, and so forth. Site content pages 310 may further include plain text, formatted text, graphics, images, video, audio, interactive elements, and so forth, or a combination thereof. Site content pages 310 may be the web pages that a client requests and loads via a web browser application. Site content pages 310 may include a set of default content that is always shown for a given web page. Site content pages 310 may also contain dynamically configurable content, or placeholders for content, where the content is supplied by content service 140 or 240 according to information about the user.

Site application 300 may include an object 320 to be served to partner sites of site application 300, such as merchant website 120, 130 or 130. Object 320 may be a graphic, image, text string, script, file, and so forth that is stored at site application 300 and is accessible to pages at a partner website. In an embodiment, object 320 may be non-visible when displayed at the partner website. For example, object 320 may be very small in size, e.g. one pixel. Object 320 may be completely transparent, or colorless, or the same color as a background. Site application 300 may provide an external link or reference to object 320 to its partner websites, such as merchant website 120, so that the partner website may include the link or reference in its own web pages.

Site application 300 may include, or have access to, data store 330. Data store 330 may store information about the users that visit site application 300 and that visit partner websites such as merchant websites 120, 130, and 220. For example, data store 330 may store information about a user and the user's activities including: the URLs visited, page types visited, the products associated with the pages visited, category of content viewed, search strings entered, products purchased, user control directives, links followed, files downloaded, previous site visited before the current site, and so forth. In an embodiment, the time that an activity occurred may also be stored.

The information that is stored may be received from the partner website when object 320 is requested, and/or from the user's client, for example, from a browser history or from a cookie file.

In an embodiment, data store 330 may include a short-term data store 332 and a longer term data store 334. Short-term data store 332 may store the most recent user data for a user's activity, for example, for a 24 hour period. In an embodiment, short-term data store 332 may be smaller in storage capacity than the longer term data store, but may be faster to access. Longer term data store 334 may store data that is older than the storage period for the short-term data store, and may store the data for longer. For example, longer term data store 334 may store data that is at least one day old, and may store it for up to three months or several years. Longer term data store 334 may be updated with the data from short-term data store 332 when the short-term data is about to be erased from short-term data store 332. Data store 330 may be indexed according to the user IDs.

Site application 300 may include user tracker 340. User tracker 340 may identify a client and keep track of the client's online activities, at least with respect to partner websites and site application 300. User tracker 340 may generate a unique user ID for a client when a partner website requests object 320.

User tracker 340 may also store data received from the partner website about the user's activity at that website. User tracker 340 may further generate a cookie file 360 for the user, which may be written to the client for that user. Cookie file 360 may include, for example, the unique user ID generated for that user by user tracker 340. In an embodiment, the cookie may also include segment information about the user.

In an embodiment, user tracker 340 may generate a unique user ID and a unique cookie for each client-merchant website pair. In another embodiment, the user ID may be unique to the client, but may be used for multiple merchant websites. If the same user ID is used across multiple merchant websites for one client, then a separate cookie may be generated for each merchant website, but each cookie generated by user tracker 340 for that user ID would contain the same user ID. In another embodiment, one cookie file may be shared across multiple merchant websites for one user ID.

Site application 300 may include segmenter 350. Segmenter 350 may detect when a previously identified client accesses site application 300. Segmenter 350 read the cookie file previously generated for the client to obtain the unique user ID and to obtain any information written to the cookie file by the merchant website it was given to. Segmenter 350 may also obtain the identity of the merchant website for which the cookie was generated. Segmenter 350 may use the user ID to extract the data stored for that user from data store 330. In an embodiment, segmenter 350 may extract data both from the short-term data store and from the longer term data store and merge the data together.

Segmenter 350 may use the data to determine a user segment for the user. Segmenter 350 may include segmenting logic to compare the data stored for a given user, e.g. an individual activity or a collected behavior event comprising multiple activities, to various criteria in order to select a segment. The criteria may be in the form of rules having one or more criteria that must be met in order to select a segment. The segmenting logic may compare the data in data store 330 with the rules. In an embodiment, rules may be indexed by merchant website, so that segmenter 350 may first compare the user's actions to the rules for one merchant website. If no rules are met for that merchant website, segmenter 350 may try matching the rules for another merchant website. When all of the conditions of a rule are met, the rule is matched, and the segment specified by the matched rule may be assigned to the user. In an embodiment, segmenter 350 may compare each rule to all of the collected data, or may stop comparing rules to the data as soon as a rule is matched. If a rule contains multiple conditions, requiring multiple activities to occur in order to match the rule, segmenter 350 may weight recent events more heavily than older events in considering whether a rule condition is met, or utilize other prioritization or weighting rules.

The segmenting logic may use one or more matching algorithms to compare the data to a rule condition and to determine whether the condition is met. For example, the segmenting logic may use a string comparison of a data item to a rule condition, if both the rule condition and the data item are stored as strings. The segmenting logic may use a neural network implemented matching algorithm, or a fuzzy logic implemented matching algorithm.

In an embodiment, such as the one shown in FIG. 2, segmenter 350 may provide the merged data for a user to content optimizing service 202. For example, segmenter 350 may provide the address to the data in data store 330, or may copy the data to content optimizing service 202. Content optimizing service 202 may include segmenting logic as described above. Content optimizing service 202 may then use the merged data from segmenter 350 to perform rule matching in order to identify a segment using the segmenting logic.

As an example, call merchant website 120, 130 “Site1” and site application 110 “Site2.” Suppose Site1 is a computer manufacturer or merchant. Site1 is in partnership with Site2 and may wish to display advertisements for peripheral computer equipment to a user at Site2 after the user has purchased a computing device at Site1. The segmenting logic at Site2 may include a rule, for Site1, having the criteria: (1) viewed Site1, and (2) completed a purchase at Site1, and (3) purchased a desktop or a laptop computer. When this rule has all three criteria met, then the segment of “needs input devices” may be assigned to the user meeting the criteria. During a user's interaction with Site1, Site 1 requested an object from Site2 and provided data about what actions the user had taken at Site1. Site2 generated a user ID, generated a cookie and placed the cookie on the user's client device. At some time after the user completed a computer purchase at Site1, the user navigates to Site2. The user may go immediately to Site2 after the purchase at Site1, or may navigate to Site2 hours or days later. When the user arrives at Site2, segmenter 350 may read the user ID from the cookie, and look up the data stored for that user. Segmenter 350 may compare each action or event to the criteria of one or more rules. For example, segmenter 350 may read, from the cookie or from the data stored for the user, that the user was at Site1 within a recent time frame, such as within three hours, or within the last seven days, and may first compare the user's actions to the rules for Site1. If all three of the criteria for the rule example above are met, then Site2 will assign the segment “needs input devices” to the user, and may request content from content service 140 for that segment. Content service 140 may then provide content 122, e.g. an advertisement for a keyboard, for display to the user in a web page from Site2. The embodiments are not limited to this example.

The components of site application 300 may be communicatively coupled via various types of communications media. The components may coordinate operations between each other. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Examples of connections may include parallel interfaces, serial interfaces, and bus interfaces.

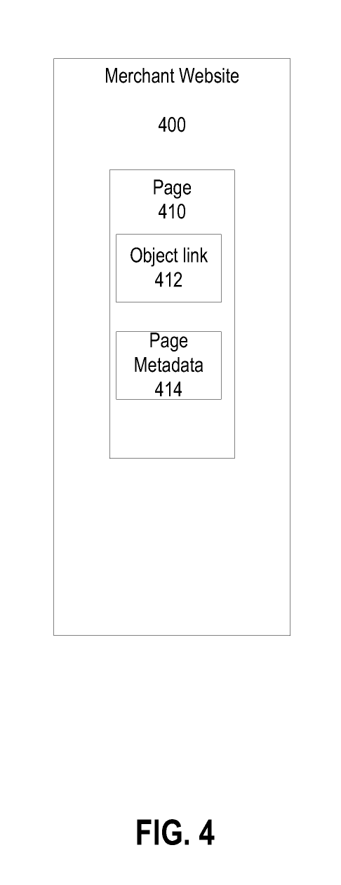

FIG. 4 illustrates a block diagram of a merchant website 400. Merchant website 400 may be a representative embodiment of merchant website 120, 130 or merchant website 220. Merchant website 400 may include one or more pages 410. A page 410 may include an object link 412 to an object served by a site application, for example, object 320. Object link 412 may take the form of an image element in HTML in the code for a web page, for example “<img src=”http://www.site2.com/object.gif “alt=”“/>”, where http://www.site2.com/object.gif is the address of the object at “site2”. Object link 412 may include additional parameters or code so that merchant website can provide more information to site application 110.

Page 410 may also include page metadata 414. Page metadata 414 may include one or more elements that provide information about the contents and function of a particular page. For example, a product information page for a digital camera may include metadata tags of <product page type>, <Site1>, <camera category>, <digital camera>, <under $200>, and so forth. Some or all of the page metadata 414 may be in a format that site application 110 can read and use with the segmenting logic. Page metadata 414 may be provided to site application 110 as part of the object request.

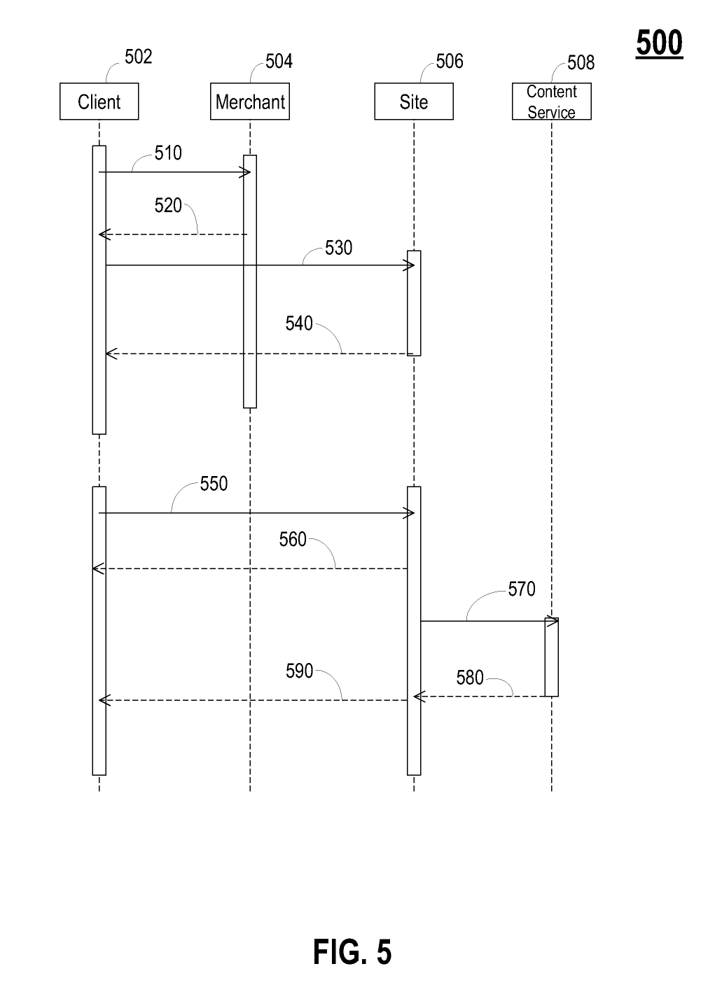

FIG. 5 illustrates a sequence diagram 500. Sequence diagram 500 shows a representative example of a series of interactions among a client 502, a merchant website 504, a site application 506, and a content service 508 according to an embodiment. As shown, time for the sequence begins at the top of the diagram and advances towards the bottom.

The sequence may begin when client 502 requests to load a web page from merchant website 504 in load request 510. Load request 510 may comprise a request from a browser operating on client 502 for the contents of a web page at a specified address on merchant website 504. Merchant website 504 may provide content from its page to client 502 in serve action 520.

As merchant website 504 begins to serve the contents of the web page to client 502, it inserts an object in the web page, e.g. object 320, from site application 506. This causes client 502 to request the object from site application 506, with load request 530. Load request 530 may include data about what the activity that the user has had at merchant website 504. If the user has had no previous activity at merchant website 504, then the load request may include at least data about the requesting page, such as, for example, a page type, a category, a product type, a subject, and so forth.

When site application 506 receives load request 530, if client 502 does not already have a cookie with an assigned user ID, site application 506 creates a unique user ID and generates a cookie that includes the unique user ID. Site application 506 communicates the cookie to client 502 in response 540. Response 540 may also include the requested object. During this time period, site application 506 may also store the data received in load request 530 in a data store indexed by the unique user ID. If the user ID had been previously assigned, then site application 506 may update its data with the information provided in load request 530, but without generating a new cookie. At some time period after one or more serve actions 520, client 502 may navigate away from merchant website 504.

At some time later, e.g. seconds, minutes, hours, or days later, client 502 requests to load a web page from site application 506 in load request 550. Load request 550 may comprise a request from a browser operating on client 502 for the contents of a web page at a specified address on site application 506.

When site application 506 receives load request 550, it begins to serve at least some content on the requested page to client 502 in serve action 560. At the same time, site application 506 reads the cookie file that it supplied in write action 540 on client 502. From the cookie file, site application 506 determines the unique user ID, collects the information written to the cookie by merchant website 504, and looks up the data stored about that user using the user ID. Site application 506 may perform segmenting using the data for that user to identify a segment to assign to the user. Site application 506 may provide the segment to content service 508 in content request 570.

Content service 508 may receive content request 570 and select content based on the segment received. Content service 508 may return the selected content to site application 506 in content return 580. Site application 506 may update the content of the page requested in load request 550 with the content from content return 580 in update 590.

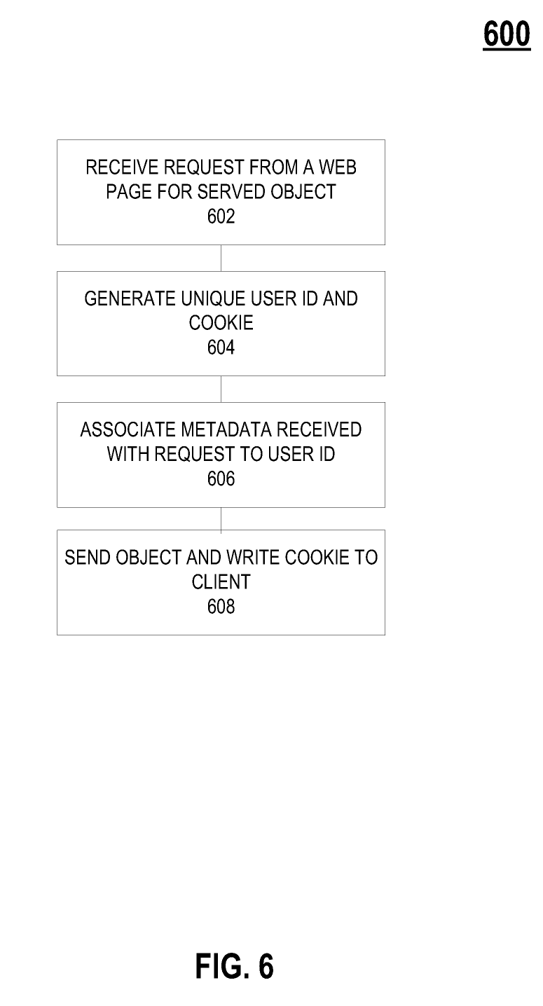

FIG. 6 illustrates a logic flow 600 in accordance with one or more embodiments. The logic flow 600 may be performed by various systems and/or devices and may be implemented as hardware, software, and/or any combination thereof, as desired for a given set of design parameters or performance constraints. For example, the logic flow 600 may be implemented by a logic device (e.g., processor) and/or logic (e.g., threading logic) comprising instructions, data, and/or code to be executed by a logic device. For purposes of illustration, and not limitation, the logic flow 600 is described with reference to FIG. 1. The logic flow 600 may be representative of a logic flow that occurs between request 510 and return 540 in FIG. 5. The embodiments are not limited in this context.

The logic flow 600 may receive a request from a web page for a served object in block 602. For example, site application 300 may receive a request from merchant website 120, 130 for object 320. The request may result from a client, e.g. client 150, requesting to load a web page from merchant website 120, 130 that contains a reference to object 320. The request may include data about the web page, including, for example, metadata about the page's type, category, subject, a site identifier, an asset, and so forth.

The logic flow 600 may generate a unique user ID and a cookie in block 604. For example, site application 110 or user tracker 340 may generate a unique user ID anonymously, or based on some characteristic of the client that is loading the web page from merchant website 120, 130. The cookie file may include at least the user ID, and may be written to and read by site application 300.

The logic flow 600 may associate the metadata received with the load request to the user ID in block 606. Associating the metadata may include storing the metadata in a memory indexed with the user ID. The memory may be a short-term or volatile memory, or a longer term or non-volatile memory. Indexing the user ID with the metadata may include using the user ID to point to a location in memory where the metadata for that user is stored.

The logic flow 600 may return the object and the cookie to the client in block 608. In an embodiment, the communication between the merchant website and the site application may end at this point.

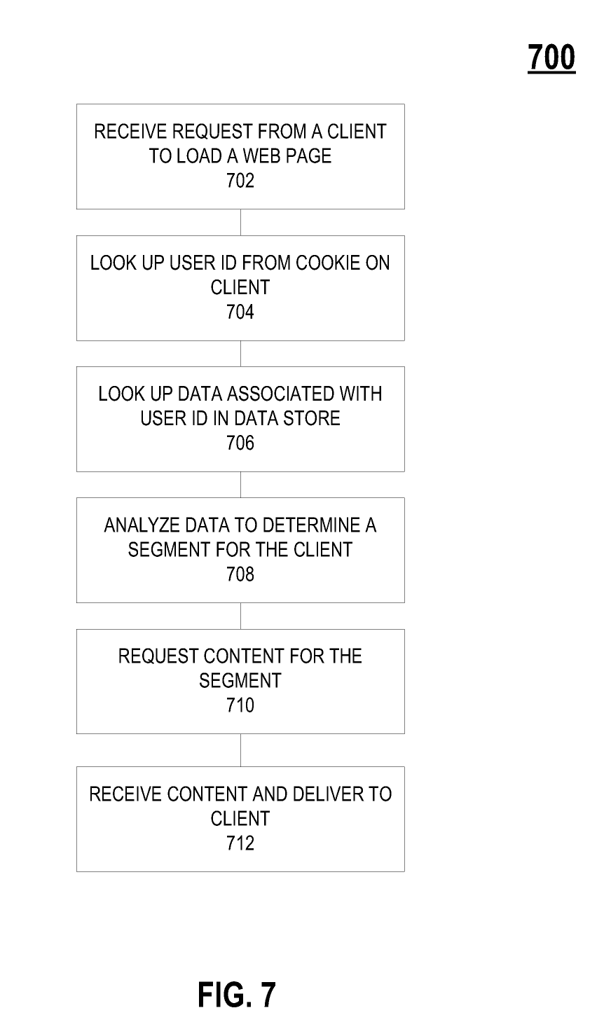

FIG. 7 illustrates a logic flow 700 in accordance with one or more embodiments. Logic flow 700 may be representative of a logic flow that occurs between request 550 and return 590 in FIG. 5. The logic flow 700 may continue or take place after the logic flow 600. The embodiments are not limited to this example.

The logic flow 700 may receive a request from a client to load a web page in block 702. For example, a site application, such as site application 110, may receive a request to load a web page from its website. The site application may be in partnership with at least one merchant website, such as merchant website 120, and the client may have previously visited the merchant website as described above. The site application 110 may serve at least some of the requested web page immediately, for example, static or default content. The web page may include one or more sections into which content can be placed or updated dynamically later.

The logic flow 700 may look up the user ID from the cookie file on the client in block 704. For example, site application 110, or segmenter 350, may read the cookie 360 and extract the user ID previously written to it by user tracker 340.

The logic flow 700 may look up the data associated with the user ID in a data store in block 706. For example, segmenter 350 may locate the address in memory indicated by the user ID, and read the data stored therein. In an embodiment, segmenter 350 may also read data from the cookie about the client's activity at the merchant website for which the cookie was generated.

The logic flow 700 may analyze the data to determine a segment for the client in block 708. For example, segmenter 350 may compare data about the content that the user of the client was viewing to the criteria of one or more rules. When a rule has all of its criteria met, segmenter 350 may determine that the segment associated with that rule should be selected.

In an embodiment, a segment may be determined by providing a pointer or link to the data to a content optimizing service so that it may perform the segmenting operation. The content optimizing service may return the segment to site application 110, or may request content from content service 140 on behalf of site application 110.

The logic flow 700 may request content for the segment in block 710. For example, site application 110 may provide the segment to content service 140 with a request for content. The segment may be represented in clear-text, using a unique identifier for a segment, or an encrypted segment. Content service 140 may use the segment to select content according to the segment. The content may be, for example, an advertisement, an article, a link, a media file, or any other information to the segment.

The segment selected by rule matching may include an identifier of the merchant website for which a cookie was generated, or identification of the merchant website may be added to or paired with the segment. For example, a company that wishes to target fans of professional basketball to sell team-branded products may have a segment <basketball fan, ABC Corp.> where “ABC Corp.” is the name of the company. Alternatively, the segment <basketball fan> may be provided to the content service with another tag or “segment” of <ABC Corp.> so that the content service selects content from ABC Corp.

The logic flow 700 may receive the requested content and deliver the content to the client in block 712. For example, site application 110, or content optimizing service 202 may insert the content into a section of the web page reserved for dynamically placed content. In an embodiment, site application 110 may rebuild the web page to include the new content and re-serve or update the page on the client browser.

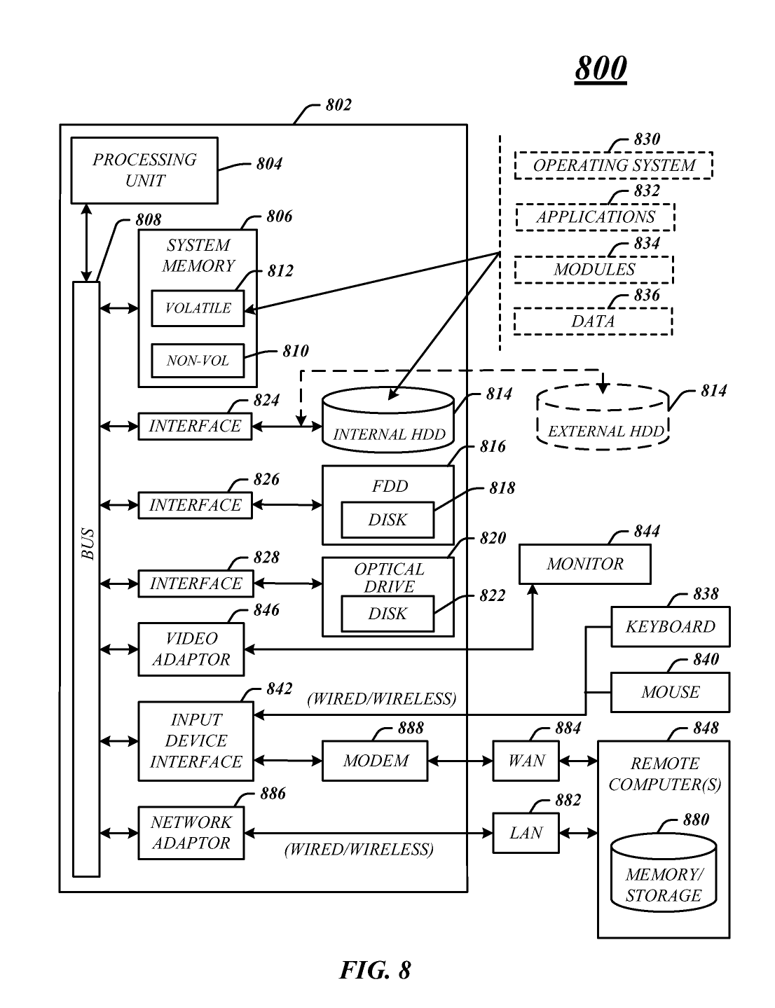

FIG. 8 illustrates a computer architecture in accordance with one or more embodiments, suitable for implementing various embodiments as previously described. The computing architecture 800 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors. Dual microprocessors and other multi-processor architectures may also be employed as the processing unit 804. The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures.

The system memory 806 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media, including an internal hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. The one or more application programs 832, other program modules 834, and program data 836 can include, for example, user tracker 340 and segmenter 350.

A user can enter commands and information into the computer 802 through one or more wire/wireless input devices, for example, a keyboard 838 and a pointing device, such as a mouse 840. Other input devices may include a microphone, an infra-red (IR) remote control, a joystick, a game pad, a stylus pen, touch screen, or the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

References to “one embodiment” or “an embodiment” mean that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A computer-implemented method comprising:
serving, at a first website, an object that may be requested by a page at a second website;
receiving, at the first website, a request to load the object, wherein the request comprises data about the page requesting the object;
assigning a user ID to a client loading the page at the second website;
associating the user ID to the data received with the request to load;
generating a cookie that includes the user ID; and
providing the cookie and the object to the client.

2. The method of claim 1, further comprising:
reading the user ID from the cookie when the client loads a page at the first website;
looking up the data associated with the user ID; and
analyzing the data to determine a segment for the client.

3. The method of claim 2, wherein analyzing the data comprises:
comparing the data to a rule having at least one criterion; and
assigning a segment associated with the rule when all of the criteria of the rule are matched.

4. The method of claim 2, further comprising:
providing the segment to a content service;
requesting content from the content service selected according to the segment; and
providing the requested content for display in the page on the client.

5. The method of claim 4, further comprising:
providing the segment and an identifier for the second website to the content source; and
requesting content according to both the segment and the identifier.

6. The method of claim 2, further comprising:
reading data written to the cookie by the second website; and
analyzing the cookie data and the data to determine the segment.

7. The method of claim 1, wherein associating the user ID to the data comprises:
storing the data in a data store; and
indexing the stored data by the user ID.

8. The method of claim 1, wherein the second website writes the cookie onto the client.

9. The method of claim 1, wherein the first website and the second website are operated by separate entities.

10. An apparatus serving a first website, the apparatus comprising:
a logic device;
a storage medium storing an object; and
a user tracker operating on the logic device to:
receive a load request for the object from an external website;
generate a user ID associated with the request;
generate a cookie including the user ID; and
provide the cookie and the object to a client viewing the external website.

11. The apparatus of claim 10, wherein the load request comprises data about the external website, the user tracker further to store the data in the storage medium and to associate the user ID with the stored data.

12. The apparatus of claim 11, further comprising:
a segmenter to:
retrieve a user ID from a cookie when a user views the first website after viewing the external website;
retrieve the data associated with the retrieved user ID;
and
use the data to assign the user to a segment for targeted advertising.

13. The apparatus of claim 12, the segmenter further to provide the segment to a content service and request that the content service select content according to the segment for display at the first website.

14. The apparatus of claim 13, wherein the assigned segment causes the content service to select content provided by the external website.

15. The apparatus of claim 13, wherein the first website displays the selected content at the first website to the user.

16. A machine-readable storage medium comprising instructions that when executed enable a computing system to:
receive a request from a page of an external website, at a site application, to serve an object, the load request comprising data about the page of the external website;
generate and return to a client viewing the requesting page a unique user ID for the client and a cookie that includes the user ID;
associate the data with the user ID;
read the user ID in the cookie on the client when the client loads a web page at the site application;
analyze the data associated with the user ID read from the cookie to determine a segment for the client; and
selecting content to display on the client according to the segment.

17. The storage medium of claim 16, further comprising instructions that when executed enable the computing system to:
store the data in a data store; and
index the stored data by the user ID.

18. The storage medium of claim 16, further comprising instructions that when executed enable the computing system to:
read data written to the cookie by the second web site; and
analyze the cookie data and the data to determine the segment.

19. The storage medium of claim 16, further comprising instructions that when executed enable the computing system to:
provide the segment to a content service;
request content from the content service selected according to the segment; and
provide the requested content for display in the page on the client.

20. The storage medium of claim 16, wherein the data comprises at least one of: a page type, a page category, a site identifier, an asset, an asset type, metadata, a product associated with a viewed page, a service associated with a viewed page, a search performed, a category of a product, a category of a service, a site identifier, a uniform resource locator (URL) of a web page, an edition of a web page, an asset type of the asset associated with a web page, a product purchased, a user control directive, a link followed, a file downloaded, and a previous website visited.
